(19) United States
(12) Patent Application Publication
(10) Pub. No.: US 2008/0095394 A1
(43) Pub. Date: Apr. 24, 2008

(54) INTEGRATED ASSEMBLY OF SPEAKER AND INTENNA, ASSEMBLY METHOD THEREOF, AND MOBILE WIRELESS COMMUNICATION TERMINAL HAVING THE SAME

(75) Inventor: Chang Hyun YOON, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/865,551

(22) Filed: Oct. 1, 2007

(30) Foreign Application Priority Data
Oct. 18, 2006 (KR) 2006-0101117

(51) Int. Cl. H04R 1/02

(52) U.S. Cl. 381/386

(57) ABSTRACT

An integrated assembly of a speaker and an intenna, and an assembly method thereof is provided. After an upper carrier and a lower carrier are assembled by bonding, the lower carrier and the speaker are mechanically assembled through coupling parts formed to the lower carrier and the speaker. A first coupling part is formed at an inner side surface of a speaker receiving space of the lower carrier, and a second coupling part is formed at an outer side surface of the speaker. The coupling parts have a female and male connecting relationship at a corresponding position to enable a mechanical bonding. Damage to the speaker that may occur during a bonding process of an intenna carrier can be prevented, and may eliminate the need of solder or an adhesive is eliminated.

### PRIORITY

This application claims priority under 35 U.S.C. §119(a) to an application entitled “INTEGRATED ASSEMBLY OF SPEAKER AND INTENNA, ASSEMBLY METHOD THEREOF, AND MOBILE WIRELESS COMMUNICATION TERMINAL HAVING THE SAME” filed in the Korean Intellectual Property Office on Oct. 18, 2006 and assigned Serial No. 2006-0101117, the contents of which are incorporated herein by reference.

### 1. FIELD OF THE INVENTION

The present invention relates to a mobile wireless communication terminal, and in particular, to an integrated assembly of a speaker and an intenna, an assembly method thereof, and a mobile wireless communication terminal having the same.

### 2. DESCRIPTION OF THE RELATED ART

Mobile wireless communication terminals such as mobile phonea or Personal Digital Assistants (PDAs) generally require an antenna. A majority of antennas used in mobile wireless communication terminals were external antennas protruding from the terminal, but with a recent trend towards miniaturization of the terminals, internal antennas built in bodies of the terminals have come into wide use. The internal antenna is referred to as ‘an intenna’.

For example, an intenna such as a Planar Inverted F-Antenna (PIFA) has one contact point connected to a Radio Frequency (RF) connector of a main board of a terminal and another contact point connected to a ground layer of the main board. In this configuration, the intenna should be installed away from the ground layer to provide an electromagnetic resonance space for sufficient bandwidth and to exhibit a good radiation characteristic. Thus, the intenna is installed on a predetermined carrier to establish a distance between the intenna and the ground layer.

Further, the mobile wireless communication terminal generally requires a speaker for performing a basic communication function. The speaker typically includes a magnet, a voice coil and a diaphragm. When a current flows through the voice coil under lines of magnetic force formed by the magnet, a Lorentz force is produced. The force enables the voice coil to vibrate the diaphragm, and air contacting the diaphragm vibrates to generate sound waves. Generally, the speaker is provided with an acoustic resonance space for improved performance.

If the intenna and the speaker are both installed in the terminal, the size and thickness of the terminal are increased. Thus, recently techniques have been introduced in which a speaker is installed in an intenna carrier to utilize an electromagnetic space of an intenna as an acoustic resonance space of the speaker. However, these conventional techniques for assembling the speaker and the intenna have the following problems:

In the conventional techniques, a speaker is inserted between an upper carrier and a lower carrier, and then the upper and lower carriers are bonded to each other so that the speaker and an intenna are assembled. At this time, bonding methods such as ultrasonic bonding, thermocompression, soldering and adhesive bonding may be used.

However, these conventional bonding methods have the following disadvantages: In a case of an ultrasonic bonding or a thermocompression method, the speaker inserted into the carriers may be damaged by ultrasonic waves or heat during a carrier bonding process. In a case of a soldering or an adhesive bonding method, used solder or adhesive may cause an environmental problem, and if the solder or adhesive is not uniformly applied, the solder or adhesive may flow into the carriers to adversely affect the performance of the speaker.

### SUMMARY OF THE INVENTION

The present invention provides an integrated assembly of a speaker and an intenna and an assembly method thereof that may effectively prevent damage of a speaker occurring during a bonding process of an intenna carrier.

The present invention further provides an integrated assembly of a speaker and an intenna and an assembly method thereof that may bond the intenna carrier without using a solder or an adhesive.

The present invention further provides a mobile wireless communication terminal having the above-mentioned integrated assembly of a speaker and an intenna.

The present invention provides an integrated assembly, in which a speaker and a carrier are mechanically assembled through coupling parts formed to an outer side surface of the speaker and an inner side surface of a speaker receiving space of a lower carrier. The present invention further provides an assembly method, in which an upper carrier and the lower carrier are bonded and then the speaker is inserted into the lower carrier to mechanically assemble the speaker and the carrier. The present invention further provides a mobile wireless communication terminal having the above-mentioned integrated assembly of a speaker and an intenna.

The integrated assembly of a speaker and an intenna according to an exemplary embodiment of the present invention includes the intenna; an upper carrier having an upper panel and a downward sidewall, the upper panel being assembled to the intenna and the downward sidewall protruding downwards from the upper panel along the edge thereof; a lower carrier having a lower panel and an upward sidewall, the upward sidewall protruding upwards from the lower panel along the edge thereof and bonded to the downward sidewall, and the lower panel having a speaker receiving space, through which an inner side surface of the lower panel is exposed; the speaker inserted into the speaker receiving space to be assembled to the lower carrier and having an outer side surface; a first coupling part formed to the inner side surface of the lower panel exposed through the speaker receiving space; and a second coupling part formed to the outer side surface of the speaker corresponding to the first coupling part; wherein the first coupling part and the second coupling part have a female and male connecting relationship and are mechanically coupled to each other.

In the integrated assembly, at least two of the first coupling parts and at least two of the second coupling parts may be formed. The first coupling part may be formed such that a portion of the inner side surface of the lower panel is indented, and the second coupling part may be formed such that a portion of the outer side surface of the speaker protrudes, wherein the second coupling part may be inclined such that it protrudes increasingly further outwards from the outer side surface in a downward direction. Further, the first coupling part may have a vertical insertion portion indented vertically in an upward direction from a lower surface of the lower panel, and a horizontal movement portion indented extending in a horizontal direction from a top portion of the vertical insertion portion. The lower carrier may further have a protrusion protruding from the lower surface of the lower panel in a downward direction.

An assembly method of the integrated assembly of a speaker and an intenna according to another exemplary embodiment of the present invention includes bonding the downward sidewall to the upward sidewall so that the upper carrier and the lower carrier are assembled; and inserting the speaker into the speaker receiving space to mechanically couple the first coupling part and the second coupling part having a female and male connecting relationship so that the lower carrier and the speaker are assembled.

The assembly method may further include, at any one of before bonding the downward sidewall to the upward sidewall, between bonding the downward sidewall to the upward sidewall and inserting the speaker into the speaker receiving space, and after inserting the speaker into the speaker receiving space, assembling the intenna and the upper carrier. Inserting the speaker into the speaker receiving space may include aligning the first coupling part and the second coupling part in position; and inserting the speaker into the speaking receiving space so that the first coupling part is fixed into the second coupling part in a press-fit manner. Alternatively, inserting the speaker into the speaker receiving space may include inserting the first coupling part into the second coupling part; and rotating the speaker so that the first coupling part is horizontally moved and fixed into the second coupling part. Further, bonding the downward sidewall to the upward sidewall may use an ultrasonic or a thermocompression bonding method.

### BRIEF DESCRIPTION OF THE DRAWINGS

The objects, features and advantages of the present invention will become more apparent from the following detailed description in conjunction with the accompanying drawings, in which:

FIG. 1 is a schematic cross-sectional view of a mobile wireless communication terminal having an integrated assembly of speaker and intenna according to an exemplary embodiment of the present invention;

FIG. 2 is a schematic exploded perspective view of an integrated assembly of a speaker and an intenna according to another exemplary embodiment of the present invention;

FIG. 3A is an enlarged perspective view of a portion of a lower carrier illustrated in FIG. 2, and FIG. 3B is an enlarged perspective view of a portion of a speaker illustrated in FIG. 2;

FIGS. 4A and 4B are cross-sectional views of an assembly method of an integrated assembly of a speaker and an intenna according to another exemplary embodiment of the present invention; and

FIG. 5A is a perspective view of a portion of a lower carrier according to another exemplary embodiment of the present invention, and FIG. 5B is a perspective view of a portion of a speaker according to another exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention.

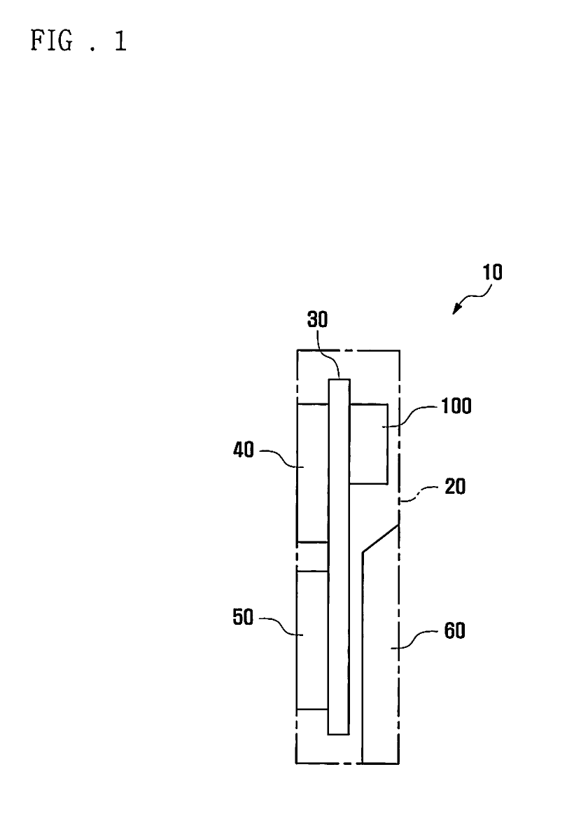

FIG. 1 is a schematic cross-sectional view of a mobile wireless communication terminal having an integrated assembly of a speaker and an intenna according to an exemplary embodiment of the present invention. Referring to FIG. 1, a mobile wireless communication terminal (hereinafter, ‘a terminal’) 10 comprises a body 20, a circuit board 30, a display unit 40, an input unit 50 and a battery pack 60, and in particular, further comprises an integrated assembly 100 of the speaker and the intenna.

The terminal 10 may be any of various types of mobile terminals and other types of terminals capable of mobile and wireless communication such as a PDA. The terminal 10 illustrated in FIG. 1 shows the body 20 as a bar-type body, however, the body 20 may be, for example, a slide-type body or a folder-type body.

The circuit board 30 is installed in the body 20, and has various electronic components for performing functions of the terminal 10 and a predetermined wiring pattern for providing an electrical path. The display unit 40 and the input unit 50 are each exposed from one surface of the body 20 and electrically connected to the circuit board 30. The display unit 40 includes a typical display device such as a Liquid Crystal Display (LCD), and visually outputs various information to be provided to a user. The input unit 50 may be a typical input device such as a keypad, a touchpad, and a jog wheel, and generates an input signal according to an operation of a user. The battery pack 60 includes a battery therein for supplying power to the terminal 10, and typically is freely attached to and detachable from the body 20.

The integrated assembly 100 of speaker and intenna is installed in the body 20 and electrically connected to the circuit board 30. The integrated assembly 100 includes an intenna, upper and lower carriers and a speaker as in a conventional integrated assembly, however the assembly 100 of the present invention has a different assembly manner and order from the conventional assembly.

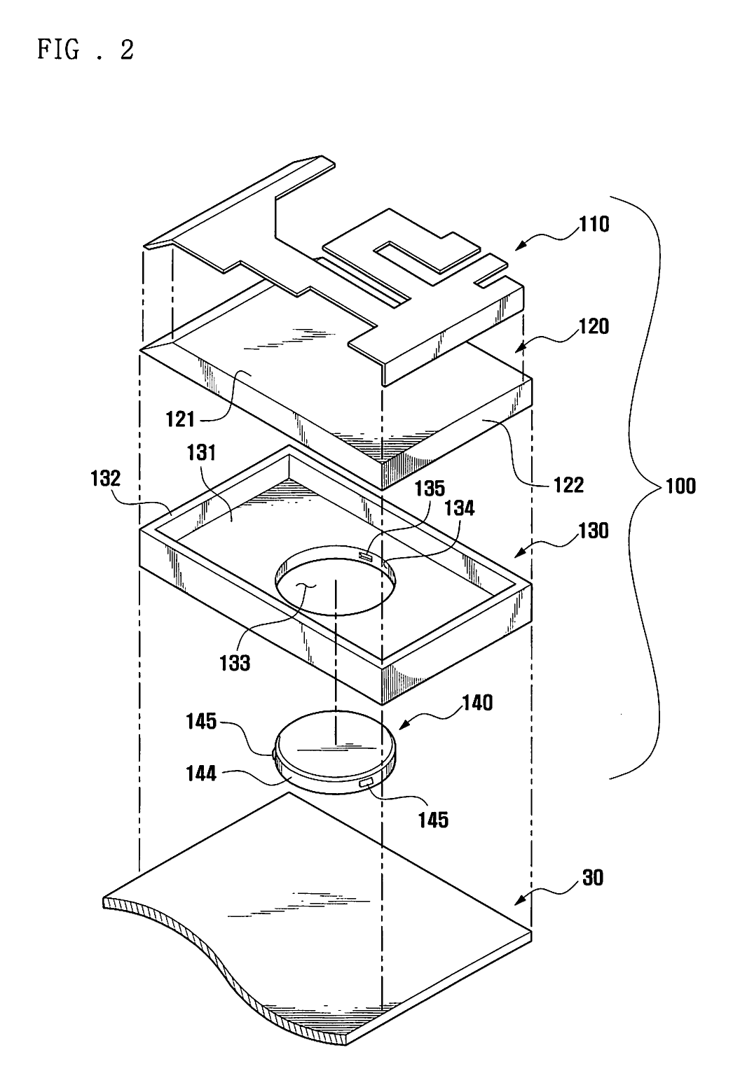

FIG. 2 is a schematic exploded perspective view of the integrated assembly 100 of a speaker and an intenna according to another exemplary embodiment of the present invention. As shown in FIG. 2, the integrated assembly 100 of speaker and intenna includes an intenna 110, an upper carrier 120, a lower carrier 130, and a speaker 140.

The intenna 110 is formed with a predetermined pattern and assembled on the upper carrier 120. The intenna 110 may be formed with various patterns according to a type of the terminal 10 or to frequencies of transmitting and receiving signals. The intenna 110 is well known in the technical field of the present invention, and thus a detailed description is omitted.

The upper carrier 120 has an upper panel 121 and a downward sidewall 122. An upper surface of the upper panel 121 is assembled onto the intenna 110, and the downward sidewall 122 protrudes downwards from the upper panel 121 along the edge thereof.

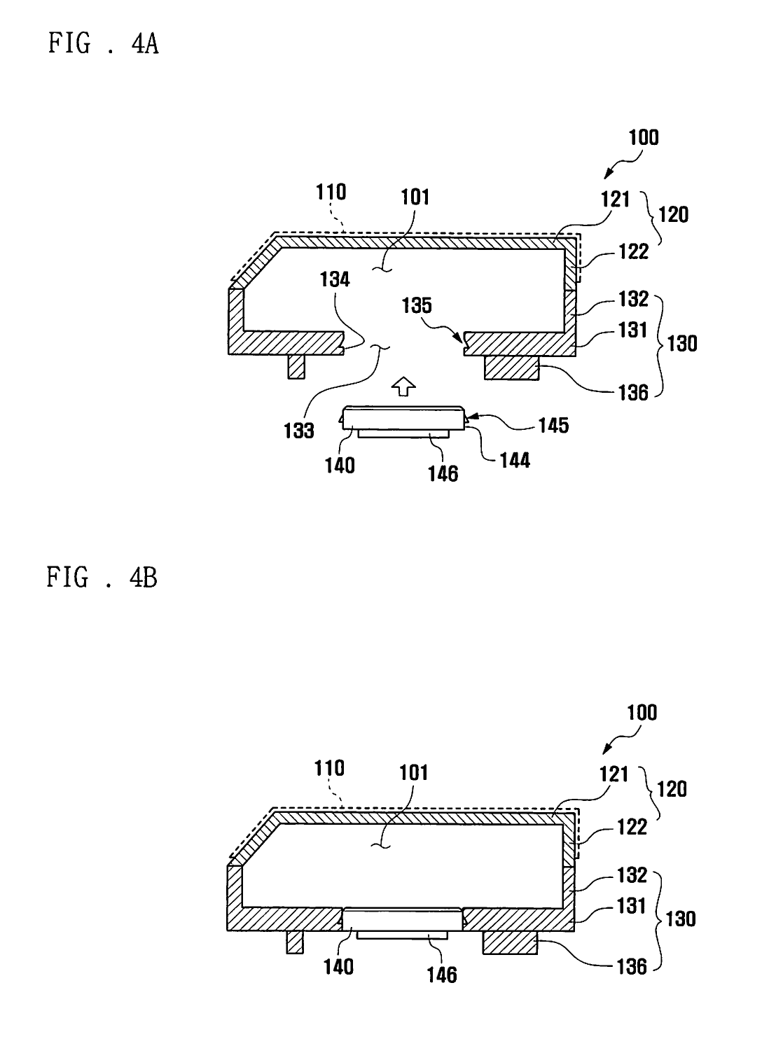

The lower carrier 130 has a lower panel 131 and an upward sidewall 132 corresponding to the upper carrier 120. The upward sidewall 132 protrudes upwards from the lower panel 131 along the edge thereof, and is bonded to the downward sidewall 122 of the upper carrier 120. As a result, the upper carrier 120 and the lower carrier 130 are assembled to form a vacant space 101 (shown in FIG. 4A) therein. The vacant space 101 serves as an electromagnetic resonance space of the intenna 110. Further, the vacant space 101 establishes a predetermined separation between the intenna 110 and the circuit board 30 by the upper carrier 120 and the lower carrier 130.

Although not illustrated in the drawings, for simplicity and clarity of the drawings, the upper carrier 120 and lower carrier 130 may have various types of additional structures mounted thereon. For example, a structure may be formed on the upper surface of the upper panel 121 for connection to the intenna 110, and a structure may be formed on a lower surface of the upper panel 121 for connection to the lower carrier 130. Similarly, a structure may be formed on an upper surface of the lower panel 131 for connection to the upper carrier 120, and a structure may be formed on a lower surface of the lower panel 131 for connection to the circuit board 30. Further, the upper carrier 120 and lower carrier 130 may have various types and configurations according to design factors.

The speaker 140 is assembled to the lower carrier 130. The lower panel 131 of the lower carrier 130 has a speaker receiving space 133, for assembly of the speaker 140 to the lower carrier 130. The speaker 140 is well known in the technical field of the present invention, and thus a detailed description is omitted. The speaker 140 may be formed of various types, and the speaker receiving space 133 has a shape corresponding to the type of the speaker 140. The speaker receiving space 133 exposes an inner side surface 134 of the lower panel 131. When the speaker 140 is inserted into the speaker receiving space 133, the inner side surface 134 is contacted with an outer side surface 144 of the speaker 140.

In particular, the inner side surface 134 of the lower panel 131 exposed through the speaker receiving space 133 of the lower carrier 130, and the outer side surface 144 of the speaker 140 inserted in the speaker receiving space 133, have coupling parts 135 and 145, respectively. The coupling parts 135 and 145 include a first coupling part 135 of the inner side surface 134 of the lower panel 131 and a second coupling part 145 of the outer side surface 144 of the speaker 140 that have a “male and female” connecting relationship and form a corresponding pair arranged at a corresponding position. The present invention has at least two pairs of corresponding coupling parts 135 and 145. FIG. 2 includes three pairs of coupling parts 135 and 145.

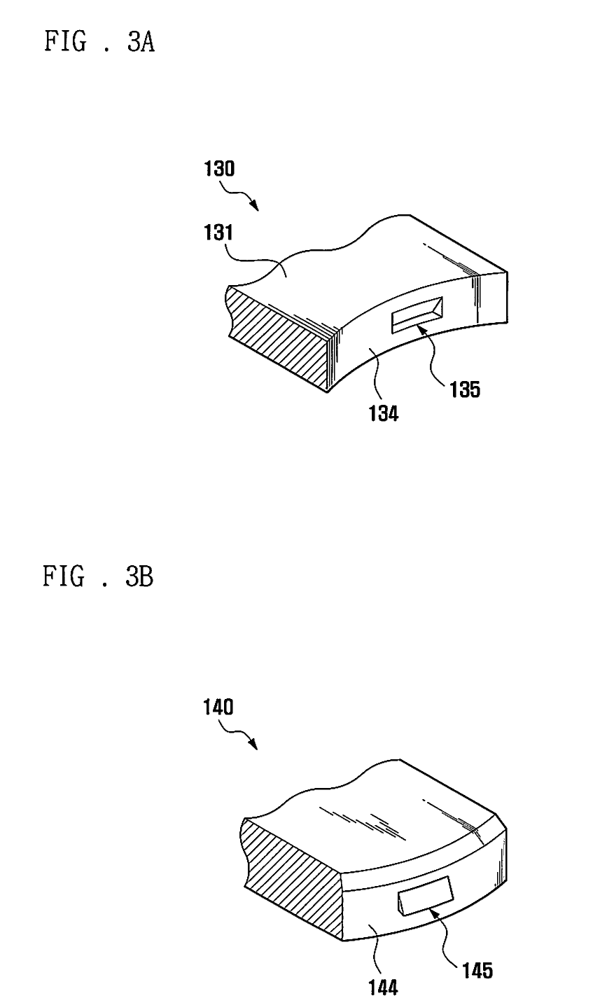

The coupling parts 135 and 145 enable a mechanical assembly between the lower carrier 130 and the speaker 140. FIGS. 3A and 3B show a configuration of each of the coupling parts 135 and 145 in detail. Referring to FIGS. 3A and 3B, the first coupling part 135 is formed such that a portion of the inner side surface 134 is indented, and the second coupling part 145 is formed such that a portion of the outer side surface 144 protrudes. As such, the coupling parts 135 and 145 have corresponding female and male forms, respectively, of a “male and female” connecting relationship, and thus the lower carrier 130 and the speaker 140 can be assembled in a press-fit manner. In particular, the second coupling part 145 may be formed on an incline such that it protrudes increasingly further outwards from the outer side surface 144 in a downward direction. In this case, when the speaker 140 is inserted into the lower carrier 130 in an upward direction, the speaker 140 may be more easily assembled to the lower carrier 130.

FIGS. 4A and 4B are cross-sectional views of an assembly method of the integrated assembly 100 of speaker and intenna according to an exemplary embodiment of the present invention.

Referring to FIG. 4A, first, the upper carrier 120 and the lower carrier 130 are assembled. That is, the downward sidewall 122 of the upper carrier 120 and the upward sidewall 132 of the lower carrier 130 are aligned in position, and bonded to each other using a typical ultrasonic bonding or thermocompression method. Thereby, before the speaker 140 is assembled, the upper and lower carriers 120 and 130 are bonded, therefore reducing the likelihood of damage to the speaker.

After the upper and lower carriers 120 and 130 are assembled, the speaker 140 is inserted into the lower carrier 130 in an upward direction. That is, the first coupling part 135 of the inner side surface 134 of the lower carrier 131 and the corresponding second coupling part 145 of the outer side surface 144 of the speaker 140 are aligned in position, and then the speaker 140 is pushed into the speaker receiving space 133. Accordingly, the first coupling part 135 is mechanically engaged with the second coupling part 145, and the speaker 140 is fixed to the lower carrier 130.

FIG. 4B shows the integrated assembly 100 after the speaker 140 is inserted, i.e. after the lower carrier 130 and the speaker 140 are assembled. The inner space 101 formed by assembling the upper carrier 120 and the lower carrier 130 serves as an electromagnetic resonance space of the intenna 110 and as an acoustic resonance space of the speaker 140. The intenna 110 may be assembled on the upper carrier 120 before or after the speaker 140 is assembled, and according to requirements, the intenna 110 may be assembled before the upper and lower carriers 120 and 130 are assembled.

The speaker 140 has a cover 146. Typically, a diaphragm is formed in the cover 146. The lower carrier 130 has a protrusion 136 protruding downwards from the lower surface of the lower panel 131. The protrusion 136 establishes a predetermined separation between the lower carrier 130 and the circuit board 30 (shown in FIG. 2) so that the speaker 140 does not come into contact with the circuit board 30. Further, a space is formed by the protrusion 136, through which a connection wiring (not shown) between the speaker 140 and the circuit board 30 may pass.

As described above, the integrated assembly of speaker and intenna according to this exemplary embodiment of the present invention has an assembly manner by which the lower carrier and the speaker are assembled through coupling parts having a “male and female” connecting relationship formed on the lower carrier and the speaker. Further, the assembly method according to this exemplary embodiment of the present invention has an assembly order in which the upper and lower carriers are first bonded and subsequently the speaker and the lower carrier are mechanically assembled. The coupling parts used in the present invention may however have other configurations to those of this exemplary embodiment, and such a configuration is described as follows.

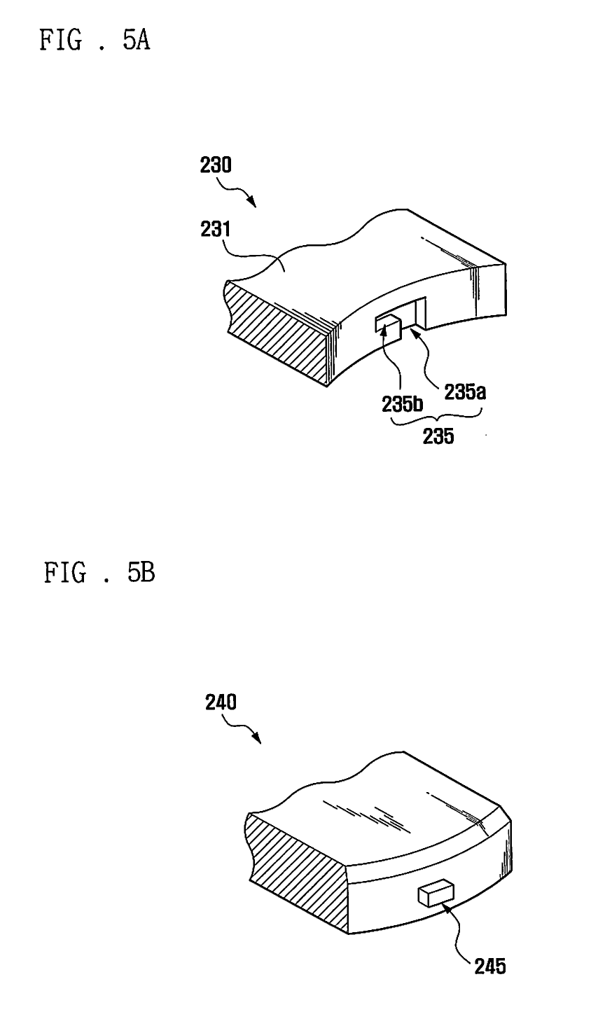

FIG. 5A is a perspective view of a portion of a lower carrier according to another exemplary embodiment of the present invention, and FIG. 5B is a perspective view of a portion of a speaker according to another exemplary embodiment of the present invention.

Referring to FIGS. 5A and 5B, a first coupling part 235 of a lower carrier 230 has a vertical insertion portion 235a and a horizontal movement portion 235b, and a second coupling part 245 of a speaker 240 protrudes from the speaker 240 without inclination. The vertical insertion portion 235a of the first coupling part 235 is indented vertically in an upper direction from a lower surface of a lower panel 231 of the lower carrier 230. When the speaker 240 is inserted into the lower carrier 230, the second coupling part 245 is inserted into the vertical insertion portion 235a. The horizontal movement portion 235b of the first coupling part 235 is indented extending in a horizontal direction from a top portion of the vertical insertion portion 235a. If the speaker 240 inserted in the lower carrier 230 is rotated in the direction of the horizontal movement portion 235b, the second coupling part 245 inserted in the vertical insertion portion 235a is moved to an inner side of the horizontal movement portion 235b. Accordingly, the lower carrier 230 and the speaker 240 are assembled.

Exemplary embodiments of the integrated assembly of speaker and intenna, the assembly method thereof and the mobile wireless communication terminal having the same according to the present invention have been described in detail, however, other embodiments can be made without departing from the spirit and scope of the present invention.

For example, the exemplary embodiments of the present invention show that the first coupling part of the lower carrier and the second coupling part of the speaker are formed to have corresponding female and male forms, respectively, of a “male and female” connecting relationship; however the first coupling part of the lower carrier and the second coupling part of the speaker may be formed to have corresponding male and female forms, respectively. Further, although the exemplary embodiments of the present invention describe a press-fit manner and an insertion/rotation manner as assembly manners of the coupling parts, various types of mechanical assembly manner may be applied.

According to the present invention, the upper carrier and the lower carrier are assembled by bonding, and subsequently the lower carrier and the speaker are mechanically assembled through the coupling parts formed on the lower carrier and the speaker. The first coupling part is formed at the inner side surface of the speaker receiving space of the lower carrier, and the second coupling part is formed at the outer side surface of the speaker. The coupling parts have a “male and female” connecting relationship at a corresponding position to enable a mechanical bonding.

Therefore, the present invention may effectively prevent damage of the speaker that may occur during a bonding process of an intenna carrier. Further, the present invention may eliminate the need of a solder or an adhesive used in the bonding process of the intenna carrier, thereby preventing an environmental problem or deterioration of the speaker. Further, the present invention allows convenient and stable assembly between the lower carrier and the speaker.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. An integrated assembly of a speaker and an intenna, the integrated assembly comprising:
the intenna;
an upper carrier having an upper panel and a downward sidewall, the upper panel being assembled to the intenna and the downward sidewall protruding downwards from the upper panel along an edge of the upper panel;
a lower carrier having a lower panel and an upward sidewall, the upward sidewall protruding upwards from the lower panel along an edge of the lower panel and bonded to the downward sidewall, and the lower panel having a speaker receiving space, through which an inner side surface of the lower panel is exposed;
the speaker inserted into the speaker receiving space to be assembled into the lower carrier, and the speaker having an outer side surface;
a first coupling part formed to the inner side surface of the lower panel exposed through the speaker receiving space; and
a second coupling part formed to the outer side surface of the speaker corresponding to the first coupling part,
wherein the first coupling part and the second coupling part have a female and male connecting relationship and are mechanically coupled to each other.

2. The integrated assembly of a speaker and an intenna of claim 1, wherein at least two of the first coupling parts and at least two of the second coupling parts are formed.

3. The integrated assembly of a speaker and an intenna of claim 1, wherein the first coupling part is formed such that a portion of the inner side surface of the lower panel is indented, and the second coupling part is formed such that a portion of the outer side surface of the speaker protrudes.

4. The integrated assembly of a speaker and an intenna of claim 3, wherein the second coupling part is inclined such that it increasingly protrudes further outwards from the outer side surface of the speaker in a downward direction from a top to a bottom of the second coupling part.

5. The integrated assembly of a speaker and an intenna of claim 3, wherein the first coupling part has a vertical insertion portion indented vertically in an upward direction from a lower surface of the lower panel, and a horizontal movement portion indented extending in a horizontal direction from a top portion of the vertical insertion portion.

6. The integrated assembly of a speaker and an intenna of claim 1, wherein the lower carrier further has a protrusion protruding from the lower surface of the lower panel in a downward direction.

7. A mobile terminal comprising the integrated assembly of claim 1.

8. An assembly method of an integrated assembly of a speaker and an intenna having the intenna; an upper carrier having an upper panel and a downward sidewall, the upper panel being assembled to the intenna and the downward sidewall protruding downwards from the upper panel along an edge of the upper panel; a lower carrier having a lower panel and an upward sidewall, the upward sidewall protruding upwards form the lower panel along the edge of the lower panel, and the lower panel having a speaker receiving space, through which an inner side surface of the lower panel is exposed; the speaker having an outer side surface; a first coupling part formed to the inner side surface of the lower panel exposed through the speaker receiving space; and a second coupling part formed to the outer side surface of the speaker corresponding to the first coupling part, the assembly method comprising:
bonding the downward sidewall to the upward sidewall so that the upper carrier and the lower carrier are assembled; and
inserting the speaker into the speaker receiving space to mechanically couple the first coupling part and the second coupling part having a female and male connecting relationship so that the lower carrier and the speaker are assembled.

9. The assembly method of an integrated assembly of claim 8, further comprising, at any one of before bonding the downward sidewall to the upward sidewall, between bonding the downward sidewall to the upward sidewall and inserting the speaker into the speaker receiving space, and after inserting the speaker into the speaker receiving space, assembling the intenna and the upper carrier.

10. The assembly method of an integrated assembly of claim 8, wherein inserting the speaker into the speaker receiving space comprises:
vertically aligning the first coupling part and the second coupling part in an assembly position; and
inserting the speaker into the speaking receiving space so that the first coupling part is fixed into the second coupling part in a press-fit manner.

11. The assembly method of an integrated assembly of claim 8, wherein inserting the speaker into the speaker receiving space comprises:
inserting the first coupling part into the second coupling part; and
rotating the speaker so that the first coupling part is horizontally moved and fixed into the second coupling part.

12. The assembly method of an integrated assembly of claim 8, wherein bonding the downward sidewall to the upward sidewall uses one of an ultrasonic and a thermocompression bonding method.
